(19) United States
(12) Patent Application Publication
(10) Pub. No.: US 2002/0159439 A1
(43) Pub. Date: Oct. 31, 2002

(54) Dynamically downloading telecommunication call services

(76) Inventors: Anita B. Marsh, Oswego, IL (US); Mark W. Beckner, St. Charles, IL (US)

Correspondence Address: Fish & Richardson P.C., Suite 2800, 45 Rockefeller Plaza, New York, NY, 10111, US

(21) Appl. No.: 09/843,429

(22) Filed: Apr. 25, 2001

(51) Int. Cl. H04L 12/66; H04L 12/56

(52) U.S. Cl. 370/352; 370/401

(57) ABSTRACT

A call service component is downloaded to a call controller that uses the call service component to support telecommunication traffic to or from a gateway under control of the call controller. Call service components, which may use a half-call model that views a call either as an originating or a terminating segment of the call, can be downloaded from a central repository. Downloading the call service can occur while the call controller is operational and supporting live traffic such that the call service is downloaded without disrupting the live traffic.

### BACKGROUND

The invention relates to dynamically downloading telecommunication call services.

Modern telecommunications systems use hardware and software to process calls and provide various services. Software used in call processing typically is fixed in the host processor of a digital telecommunications switch. When a call segment is initiated, a particular software routine is called and executed.

Upgrades often need to be made to the telecommunications system. The upgrades can implement new features, change the configuration of a switch, improve efficiency, or eliminate software bugs. Service providers would like to be able to define and implement their own services and features. However, it is difficult for a carrier to install its own services and features in a switch obtained from another entity.

### SUMMARY

In general, techniques are disclosed that include downloading a call service component to a call controller and using the call service component to support telecommunication traffic to or from a gateway under control of the call controller.

In various implementations, one or more of the following features may be present. The call service can be downloaded while the call controller is operational and supporting live traffic, and the call service can be downloaded without disrupting the live traffic.

When a network carrier turns on a service, corresponding to the call service component for a particular user area the call service component can be dynamically downloaded. The call service component can be downloaded either from a local compact disk (CD) or remotely through an Internet Protocol (IP) network from a central repository. The call service component can subsequently be dynamically removed from the call controller when no longer needed.

The call service component can use a half-call model that views a call as an originating segment and one or more terminating segments or call “legs”. Each segment of the call can provide services and handle access protocols according to the downloaded call service component with which the segment is associated. Each call service component can include a wrapper surrounding a set of core functions, wherein the wrapper supports dynamic downloading of the component to the call controller. In some implementations, the service call components use the Java™ language with a Java bean wrapper surrounding a set of core functions.

A call service component can include, for example, an application component for implementing call behavior or a resource component for providing access to telephony resources by an application component.

The techniques can include establishing a call having an originating segment that uses the call service component downloaded to the call controller. The call service component downloaded to the call controller can handle both call originations and terminations for a given type of service.

Similarly, the techniques can include establishing a call having a terminating segment that uses a call service component previously downloaded to the call controller. A call originating with one service component can have a terminating segment that represents a different call type.

Systems implementing the foregoing techniques also are disclosed.

In various implementations, one or more of the following advantages may be present. The techniques can allow multiple, independent development organizations to create software service components that can co-exist and cooperate in the runtime environment of the call controller, also referred to as softswitch. The softswitch architecture can help facilitate the implementation of multiple call models that can be downloaded on demand as services are required in the carrier network. The services can be downloaded without a maintenance outage and without restarting the system. The softswitch architecture can provide a common infrastructure for a wide range of call resources with an application programming interface used by various call models. Furthermore, the architecture can support the interworking of calls originating in one access type and terminating in another access type such that details of the access type are transparent to the call services. For example, a call forwarding service could be provided regardless of whether the access type is for a Global System for Mobile Communications (GSM) wireless network or a wireline System Signaling 7 (SS7) network.

Other features and advantages will be readily apparent from the detailed description, the accompanying drawings and the claims.

### BRIEF DESCRIPTION OF THE DRAWINGS

FIG. 1 illustrates a communications system.

FIG. 2 is a functional diagram of a call controller or softswitch.

FIG. 3 illustrates a softswitch architecture for supporting independent call models.

FIG. 4 illustrates dynamic downloading of a service component to the softswitch.

FIG. 5 illustrates application programming interfaces in a softswitch.

FIG. 6 illustrates initial configuration and deployment of a softswitch.

FIG. 7 illustrates a call scenario using multiple call models.

FIG. 8 is a flow diagram for signals corresponding to the call scenario of FIG. 7.

FIG. 9 is an alternative flow diagram where SIP protocol signals are exchanged between the softswitches.

### DETAILED DESCRIPTION

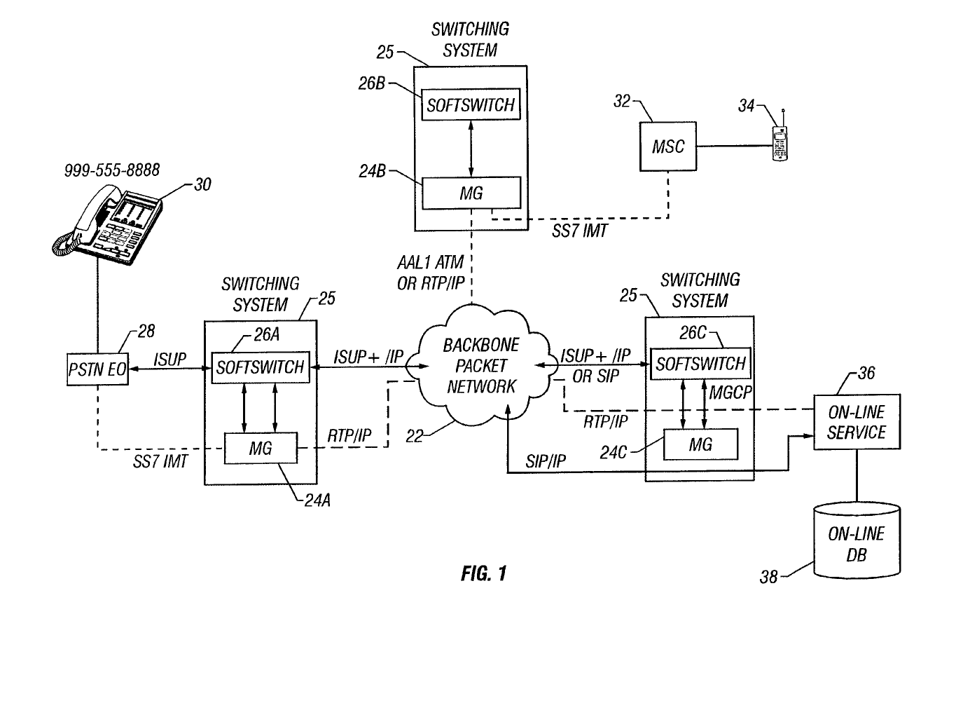

As shown in FIG. 1, a telecommunications system 20 includes a packet backbone network, such as an asynchronous transfer mode (ATM) or Internet Protocol (IP) network 22. Calls are made between gateways 25 under the control of call controllers 26, also referred to as softswitches, using the backbone network 20. The softswitches 26 can provide different call models. Media gateways 24A, 24B, 24C (collectively 24) provide the physical layer adaptation between the core telephone network and various access networks. The media gateways 24 may support, for example, voice over Internet Protocol (VoIP) calls, voice over asynchronous transfer mode (VoATM) calls Signaling System 7 (SS7) and Primary Rate Interface (PRI) circuit-switched calls.

Other equipment in the system of FIG. 1 includes an IP-based server 36 and an associated database 38 for providing on-line services to customers. A Public Switched Telephone Network (PSTN) end-office 28 can be coupled to a user's telephone 30. Similarly, a Mobile Switching Center (MSC) 32 can be coupled to the user's wireless telephone 34. In FIG. 1, bearer paths are illustrated by dashed lines through the media gateways 24 and/or backbone network 22. The bearer paths may use different protocols including, for example, Real Time Protocol/Inetrnet Protocol (RTP/IP), Intergrated Services Digital Network User Part (ISUP)/IP, SS7 and ATM Adaptation Layer Type 1 Protocol. Signaling, or control, channels that serve as logical protocol links are illustrated by solid lines.

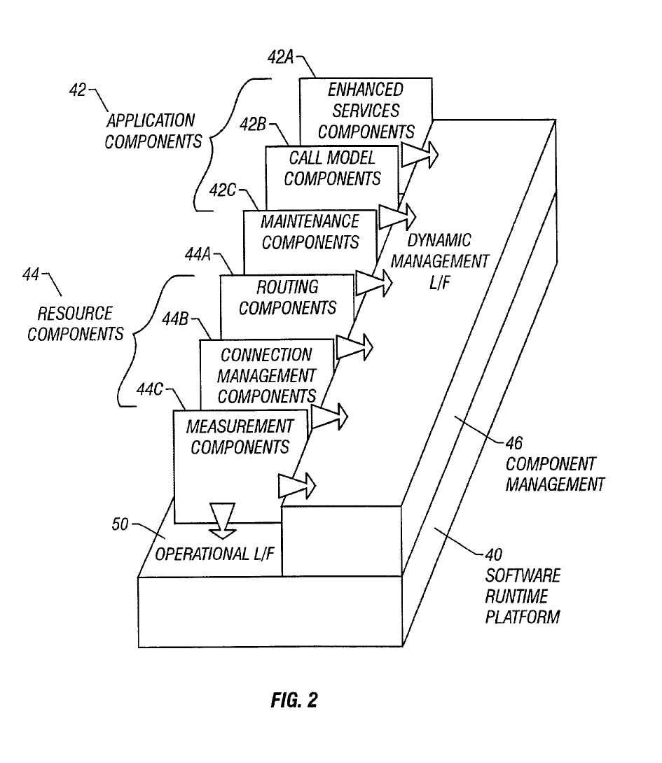

As shown in FIG. 2, each softswitch 26 includes a runtime platform 40 that supports the configuration, downloading and execution of software service components. Application components 42 implement call behavior and services and use the platform 40 to provide services to users. In general, application components 42 may be classified, for example, as enhanced services components 42A, call model components 42B, or maintenance components 42C.

Resource components 44 control and provide access to the telephony resources to the application components 42. The services provided by the resource components 44 can include address translation and routing, alarm notification and logging, performance and/or traffic count archival and offload to operations systems, as well as generation of billing data.

The resource components 44 also allow application components 42 to manage calls from the perspective of logical endpoints and, therefore, provide the mapping between a logical endpoint and a specific port at a media gateway 24. Resource components 44 can provide a mapping from the logical endpoints to a specific gateway 24, hardware card or port, and media stream. Examples of resource components 44 include translation components that map a directory number, a universal resource locator (URL) or an IP address to a media gateway 24 capable of handling the call. One function of resource components 44 is to manage the mapping of call resource requests to the underlying transport protocol between the softswitch 26 and gateway 24.

In some implementations, resource components 44 can be classified as routing components 44A, connection management components 44B, or measurement components 44C. Other components may include generalized alarm logging, billing, performance count archiving and audit functions. A common set of telephony infrastructure required by all call control services is supported in these resource components. Each of the application and resource components 42, 44 may be developed by the same or different, independent development organizations.

A management system 46 supports the dynamic deployment, configuration and operation of application and resource components 42, 44 in a service provider's network. Services can be downloaded as the carrier turns them on for a particular service area, rather than on a per-call basis.

The management system establishes a binding between physical media streams and downloaded components to perform various softswitch operations such as originating or completing calls. This allows the services and access protocol at a particular time domain multiplexed (TDM) or packet interface at a specific media gateway to be handled with a specific downloaded component. The management system also allows a component 42, 44 to identify and dynamically bind itself to other components, thus modifying call behavior of a currently operational service.

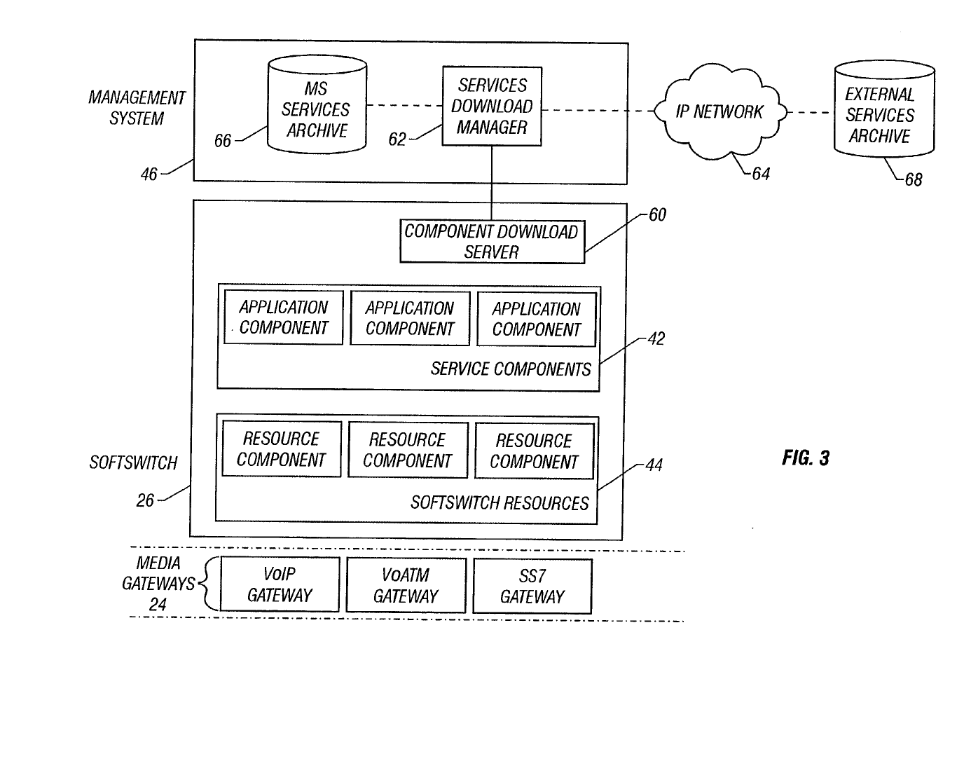

As illustrated in FIG. 3, the process of downloading services involves a manager 62 in the management system 46 and a download server 60 in the softswitch 26. The manager 62 and server 60 can use, for example, the Java Dynamic Management Kit (JDMK). JDMK provides a framework for building and distributing management services through a set of Java classes and tools that simplify the development of dynamically extensible components. JDMK supports an agent framework, including a library of reusable core agent services in the form of management components based on JavaBeans™ technology. Agent applications provide one or more services and can download management services from the management server. The services can be stored either in an internal repository 66 or in an external server 68 in the carrier's IP network 64.

Service components 42, 44 are downloaded from the manager 62 to the server 60 when the carrier turns on a new service, for example, when new access interfaces are configured at a gateway 24 or when gateways 24 with new capabilities are added. When a service no longer is needed, the service component(s) can be removed from the softswitch 26.

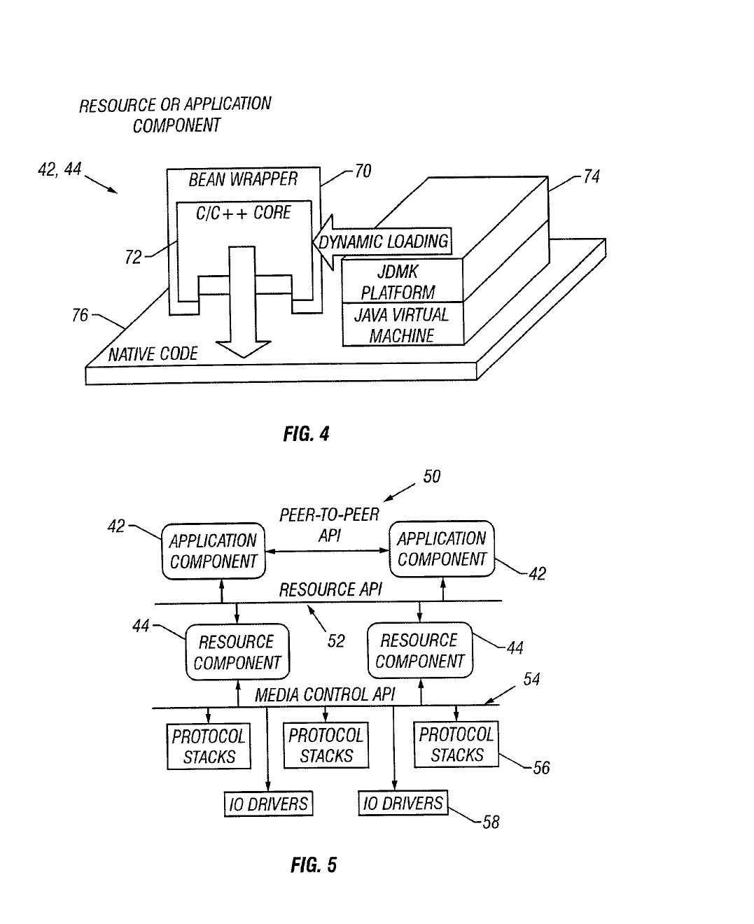

As shown in FIG. 4, the service components 42, 44 can be implemented as Java beans that act as a wrapper 70 surrounding a set of core functions 72 written in a more performance-efficient language such as the C language. The Java bean wrapper 70 supports the dynamic loading of components from the repository 66 (or 68). In particular, the management system 46 directs the downloading of components 42, 44 to the softswitch 26 through the JDMK framework 74 as well as controls configuration of affected gateway 25 and call controller data. In the particular implementation of FIG. 4, a Java virtual machine 78 can provide the environment in which the JDMK runs. Different frameworks can be used in other implementations to support the downloading of service components.

The set of core functions 72 provides functionality for the resource or application component 42, 44. The core functions 72 can be written, for example, in computer languages such as C or C++ to provide real-time, high performance processing. The core functions can be multi-threaded and can be executed, for example, as native UNIX-compiled code 76. In other words, after a component 42, 44 is downloaded to the softswitch 26 and initialized, the component no longer needs to use the functions supported by the Java bean wrapper 70. Rather, the component 42, 44 is executed as native UNIX C/C++ code.

Softswitch Application Programming Interfaces (APIs)

As illustrated in FIG. 5, the softswitch 26 includes several application programming interfaces (APIs): the operational peer-to-peer API 50, a resource API 52 and a media control API 54. The APIs 50, 52, 54 allow the application components 42 to manage calls and call resources. Call model components 42 are implemented using a half-call model such that each application component 42 views a call from the perspective of one segment of the call—either as the originating segment or the terminating segment.

The peer-to-peer API 50 is used to connect an originating call model component 42 to a terminating call model component. The originating and terminating components 42 communicate and exchange call status through the API 50. Call control and progress information is exchanged between peer application components 42 and, when the call terminates, the peer-to-peer API 50 removes the connection.

The peer-to-peer API 50 allows calls to use any of the specific call model components 42 that are present on the softswitch 26. Each segment of the call handles the services and access protocols specific to the component with which it is associated in a manner that is transparent to the other call segments. For example, an Integrated Services Digital Network User Part (ISUP) originating trunk could interwork with a Simple Internet Protocol (SIP) IP-based terminating session. The peer-to-peer API 50 uses resource descriptors to manage the calls. Thus, an originating call identifier and a translation resource descriptor can be passed as parameters to a connection segment to establish a call. When the connection segment is invoked, an execution thread is set up in an application component 42 to handle the terminating segment of the call.

The resource API 52 supports the allocation of telephone resources by the application components 42 and supports the transport of control messages. The media control API 54 is used by resource components 44 to manage connections and control signaling at the gateway nodes. When a resource component 44 receives a control message from an application component 42 directed to a particular logical signaling channel, the media control API 54 maps the logical channel to the appropriate port and protocol. For each control channel, a gateway identifier, a protocol type and a port identifier are passed as parameters. Details of the underlying transport drivers 56 and protocol stacks 58 supported by the particular gateway 24 are transparent to the resource components 44.

Each API 50, 52, 54 has various primitives associated with it. For example, the peer-to-peer API 50 includes the following primitives: (1) create call, (2) add segment, (3) call progress, (4) answer, (5) hang up, (6) call completed, (7) redirect and (8) drop segment. The “create call” primitive establishes a call between an originating application 42 and a terminating application 42. In addition to establishing a logical connection between the originating and terminating applications, the “create call” primitive causes a connection to be established through the bearer fabric using the media control API 54.

The “add segment” primitive adds an additional half-call instance to an existing call. The “call progress” primitive sends a call progress status, such as busy or ringing, from the terminating application to the originating application. The “answer” primitive provides notification of an answer at the terminating application. The “hang up” primitive provides notification from either the originating or terminating application that the bearer connection has been lost. The “call completed” primitive terminates the peer-level association between call segments and terminates per-call signaling association. The “redirect” primitive terminates the association with the peer call application and causes a new call to be established to the particular application component 42 indicated in the “redirect” primitive. A redirect operation can occur, for example, in connection with services such as call forwarding. After the call has been established between two call application components, the terminating call application can redirect the call. The “drop segment” primitive removes the half-call from the current call, thereby terminating bearer connections for that call segment.

The resource API 52 includes the following primitives: (1) call origination, (2) translate directory number, (3) translate URL, (4) send signal, (5) receive signal and (6) generate alarm. The “call origination” primitive provides notification of call origination to an originating application component 42. For example, if a signaling message for which no application component is designated arrives at the media control interface 54, a call origination notification is generated for a new instance of the appropriate originating application component 42. The notification includes an identification of the control channel as well as the complete control message.

The “translate directory number” primitive maps a directory number and call parameters, such as bandwidth and encoding method, to a media gateway 24 and bearer stream capable of terminating the call. A resource component 44 translates the digit string to a media gateway 24 and bearer channel capable of handling the call and returns a response that includes the network address of the media gateway. As part of associating a gateway 24 and media stream with a specific access protocol, a callback function performs connection access control (CAC). The CAC callback function can be specific both to the access interface supported by the media gateway 24 as well as the application associated with the channel. Call requirements such as bandwidth, voice encoding and encryption are used by the CAC function to select a gateway/bearer channel. If no suitable resource is available to handle the call, the resource component 44 returns a negative response to the application.

The “translate URL” primitive maps a World Wide Web universal resource locator (URL) or IP address and corresponding call parameters to a media gateway and IP port capable of terminating the call. As with directory number translation, translation of a URL produces a pointer to a media gateway and IP port capable of handling the call. A CAC function can be associated with the URL translation to evaluate call parameters such as bandwidth, voice encoding and encryption methods.

The “send signal” primitive sends a control signal to a logical endpoint. The parameters sent for signaling can include an identification of the control channel as well as the signaling parameters such as message type. The “receive signal” primitive receives control information from a logical endpoint and identifies the control interface. Details of the signaling information depend on the type of control channel, but can include the signal type, control channel identification, addressing information and message content.

The “generate alarm” primitive generates an alarm event with local logging and notification to a remote management system (not shown). Other primitives may be included as well.

The media control API 54 can include the following primitives: (1) activate control channel, (2) deactivate control channel, (3) send control information, (4) receive control information, and (5) control channel notification. The “activate control channel” primitive is sent from a resource component 44 to initiate control communication for a particular control channel and to associate the resource component with an underlying protocol stack 56 and input/output interface 58. Although many details of the protocol stacks 56 are transparent to the resource components 44, the resource components are aware of differences in control mechanisms among the protocol stacks. The “deactivate control channel” primitive is sent from a resource component 44 to block use of a specified control channel and to disassociate the resource component from the control channel.

As discussed above, the resource API 52 contains a “send signal” primitive. A resource component 44 obtains control information from the “send signal” primitive and forwards that information to the “send control information” primitive associated with the media control API 54. The “send control information” primitive sends the control information over the specified control channel. The “receive control information” primitive performs the opposite function with respect to control information received from a control channel. The “control channel notification” primitive is used to notify a resource component 44 of a change in the operational status of an active control channel.

Some resource API primitives, such as “create call, “add segment,” “call completed,” “redirect” and “drop segment,” result in changes in connections at the bearer fabric. To implement those changes, execution of resource API primitives can result in calls to media control API primitives such as “send control information” and “receive control information” to manage the bearer path through the media gateway(s).

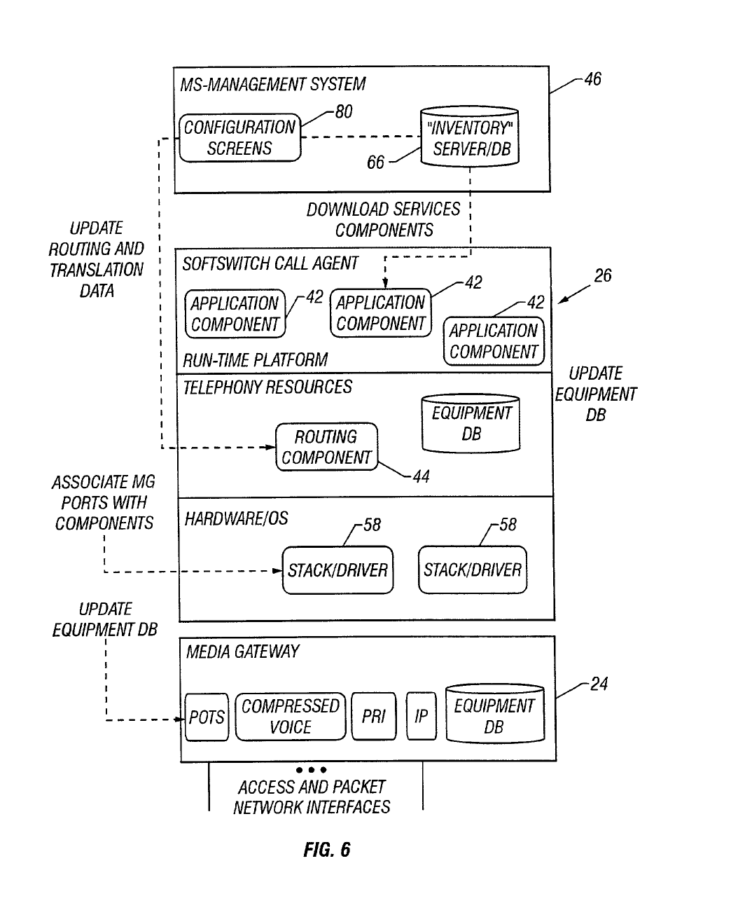

A process of downloading call services to a softswitch 26 is illustrated in FIG. 6. Graphical user interfaces 80 are used to configure the media gateways 24 and the softswitch 26, as well as switches and routers in the backbone network 22. Hardware cards and network connections are installed and configured at the media gateways 24 and softswitch 26 to support the call services. Next, selected call services are downloaded from the repository 66 of services. For example, in one implementation, services for ISUP, ISUP+, Primary Rate Interface (PRI) and wireless applications are downloaded. The management system 46 downloads the service components using JDMK application programming interfaces. The management system 46 associates ports and endpoints at the media gateways 24 with service protocols using Signaling Network Management Protocol (SNMP) and the JDMK application programming interfaces. The management system 46 also establishes control channel transport. Resource components 44 for call translation and routing data, such as dialing plans and office codes associated with SS7 trunk circuits, are downloaded using SNMP and the JDMK application programming interfaces. Live traffic then can be sent over the network 22 using the softswitch 26.

To install new services, the appropriate software components 42, 44 are downloaded from the management system 46. The JDMK toolkit is used by the management system 46 to push the software components to the softswitch 26. At the softswitch 26, the JDMK framework 74 and the Java virtual machine 78 are responsible for reading the downloaded Java beans representing the software components 42, 44 and initializing execution of the service components.

The management system 46 also can be used to update existing service components. The new version can be downloaded without loss of calls and without the need for a softswitch 26 or media gateway 24 to be reset. When execution threads within an older version of a software component are no longer active, the unused component can be unloaded using the JDMK application programming interface. Such upgrades can be performed without loss of call traffic. When service applications are no longer required in the network, the media gateway 24 can be reconfigured to support other access types, and the old call service applications can be unloaded from the softswitch 26.

Example of a Call Scenario

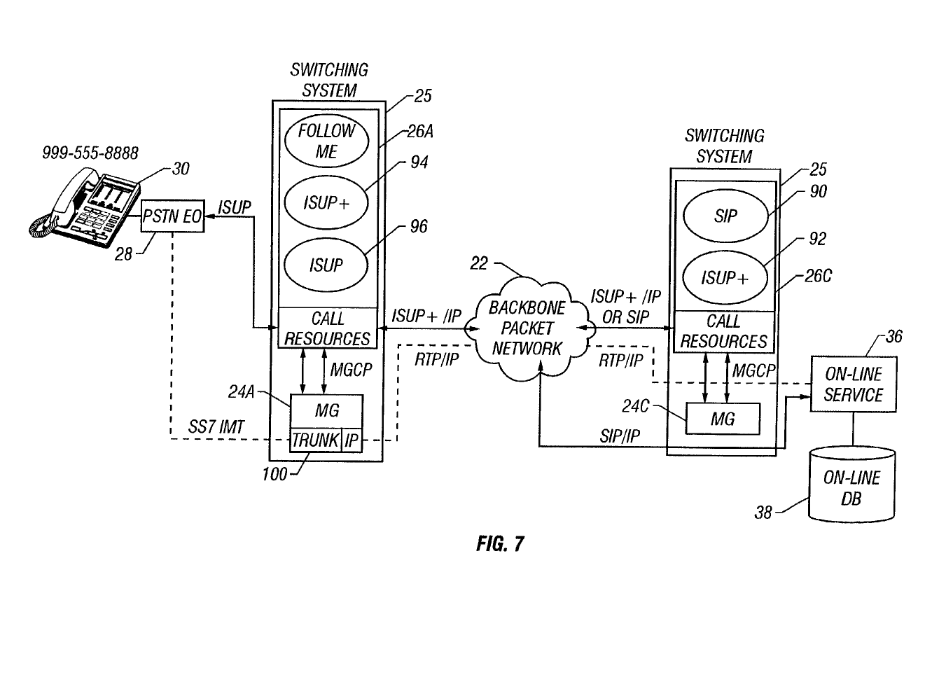

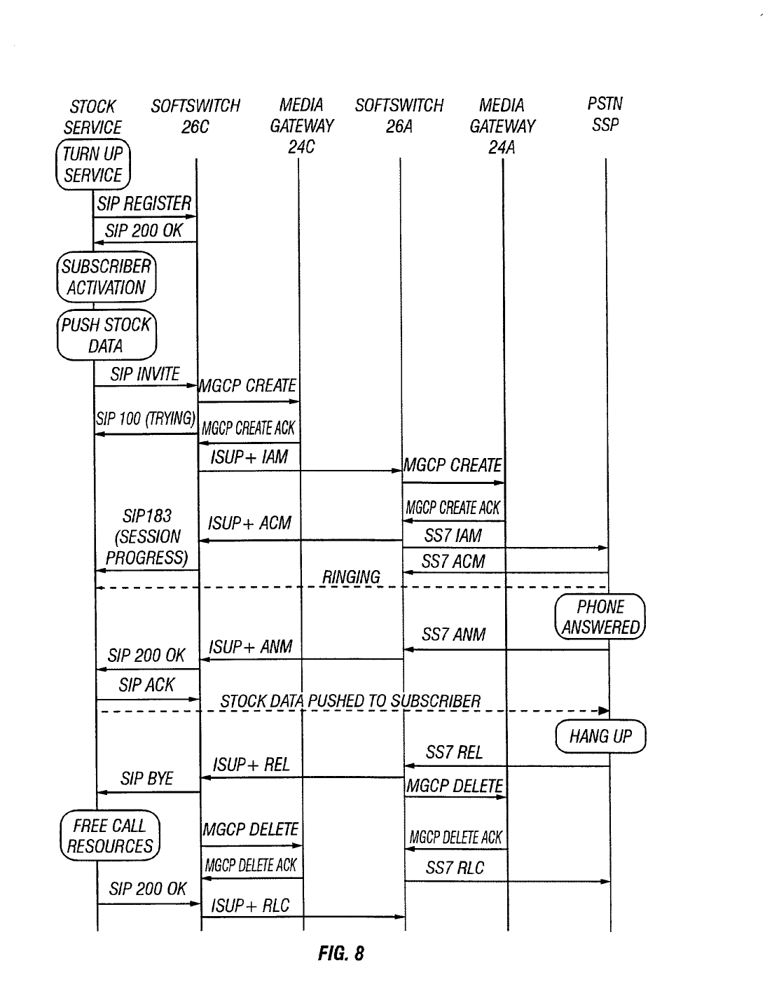

A call scenario is illustrated by FIGS. 7 and 8 in which the gateways 25 are controlled by different softswitches 26. The bearer path is shown as dashed lines through the media gateway 24A and backbone IP network 22. Control channels are shown with solid lines. In the illustrated scenario, four different call models are supported at the various softswitches: SIP, SS7 ISUP, ISUP+ and wireless. In addition, an enhanced “follow-me” or one-number service is supported by the softswitch 26A. It is assumed that an on-line stock quote service 36 has signed up subscribers who wish to have periodic updates of their personal stock portfolios sent to them. The update is provided to the subscriber's telephone 30. The “follow-me” service in the softswitch 26A allows the information to be provided to the subscriber by electronic mail, wireline, wireless or IP phone depending on the subscriber's location. It is further assumed that the stock quote service 36 uses SIP-based equipment.

The stock quote service 36 registers it's SIP telephone with the carrier when service is turned on using a SIP REGISTER message sent directly to the softswitch 26C through the backbone IP network 22. The SIP protocol software forwards the control message to a SIP resource component using the “receive control information” primitive at the media control API. The SIP resource component in the softswitch 26C updates information for SIP calls with the IP address and telephone number and/or URL of the service 36. The SIP resource component also acknowledges the successful registration using the “send control information” primitive at the media control API.

The subscriber signs up for on-line stock quote service using a particular telephone number, for example, 999-555-3070. Subscriber information is stored in a database 38 associated with the service 36.

It is assumed that, at some later time, the on-line service 36 determines that stock information should be sent to the subscriber. A SIP INVITE message is sent directly to the softswitch 26C through the backbone IP network 22. The address field of the SIP message contains the PSTN directory number 999-555-3070. The INVITE message is forwarded to a SIP resource component in the softswitch 26C using the “receive control information” primitive at the media control API. The SIP resource component recognizes the new call and invokes the “call origination” primitive to be sent through the resource API to a SIP application component 90. A new instance of the SIP application component 90 receives the “call origination” primitive and allocates resources to the call. The SIP application component 90 also returns a SIP acknowledgement message to the service 36 using the “send signal” primitive at the resource API to indicate that call setup is underway. A SIP resource component uses the “send control information” primitive at the media control API to send the control message to the SIP stack/driver.

The softswitch SIP application component 90 translates the directory number 999-555-3070 using the “translate directory number” primitive at the resources API. A resource component determines that the directory number is not a line that terminates at the softswitch 26C, but rather terminates at a remote softswitch. If more than one softswitch can handle the call, the local softswitch 26C selects a specific softswitch at which the call will terminate.

Call descriptor information is returned to the SIP application component 90 and is passed as a parameter in the “create call” primitive at the peer-to-peer API. The “create call” primitive also includes normalized call status that is exchanged between the originating and terminating application components. An ISUP+ call component 92 handles the terminating segment of the call and sends an ISUP+ initial address message (IAM) to the remote softswitch 26A to initiate setup of a bearer path through the backbone IP network 22. The ISUP+ application component 92 also initiates allocation of bearer path resources using the “send signal” primitive at the resource API. A Media Gateway Control Protocol (MGCP) message containing port allocation information and other parameters specific to the call path is generated and sent to the gateway 24C. Control messages are sent to the appropriate stack/driver software.

The remote softswitch 26A receives the ISUP+ initial address message (IAM) at a SS7 driver/stack function. The message is forwarded to a SS7 resource component in the softswitch 26A using the “receive control information” primitive at the media control API. The SS7 resource component recognizes the new call and invokes the “call origination” primitive at the resource API which is sent to a SS7 ISUP+ application component 94. The application component 94 allocates resources to the call and uses the “translate directory number” primitive at the resource API to route the call. As part of the directory number translation, a SS7 resource component recognizes that a call to the “follow-me” callback function is required to route the call properly. It is assumed in this example, that the “follow-me” callback function knows that the subscriber is currently receiving calls at its wireline telephone number 999-555-8888. The digit translation resource component performs digit translation/routing for the telephone number 999-555-8888 that terminates at the PSTN circuit switch 28 using SS7 ISUP trunks.

Call descriptor information is returned to the ISUP+ application component 94 and passed as a parameter to the “create call” primitive at the peer-to-peer API. The new instance of the ISUP application component 96 handles the terminating segment of the call and sends an ISUP initial address message to the PSTN switch 28 using the “send signal” primitive at the resource API. The control message is sent to the appropriate stack/driver software. If, instead of the user's telephone 30, the user's wireless telephone 34 or e-mail/voice-mail system were currently handling the subscriber's calls, the call descriptor information would contain pointers to wireless or e-mail/voice-mail application components. In that case, the “create call” primitive would terminate at a wireless or e-mail/voice-mail component rather than the ISUP application component 96.

The ISUP+ application component 94 initiates the allocation of bearer path resources at the gateway 24A using the “send signal” primitive at the resource API. In this case, a MGCP message containing port allocation information and other parameters specific to the call path is generated and sent to the gateway 24A. The ISUP+ application component 94 sends an ISUP+ address complete message (ACM) to the originating softswitch 26C using the “send signal” primitive at the resource API. Control messages are sent to the appropriate stack/driver software.

The PSTN circuit switch 28 terminates the call, requests calling name information, and rings the telephone 30. The PSTN circuit switch 28 then returns an SS7 ISUP address complete message. The remote ISUP application component 96 receives the address complete message and provides a message indicating “ringing” status to the ISUP+ application component 94 using the “call progress” primitive at the peer-to-peer API. The remote ISUP+ application component 94 sends an ISUP+ address complete message to the local ISUP+ application component 92 using the “send signal” primitive at the resource API. Control messages are received from and sent to the appropriate stack/driver software.

The local ISUP+ application component 92 receives the address complete message using the “receive signal” primitive at the resource API and forwards status information to the SIP application component 90 using the “call progress” primitive at the peer-to-peer API. The SIP application component 90 sends an acknowledgment message using the “send signal” primitive at the resource API to inform the on-line stock service 36 of the ringing at the remote telephone 30.

Assuming that the subscriber answers the telephone 30, the PSTN circuit switch 28 returns an SS7 ISUP address complete message. The remote ISUP application component 96 receives the address complete message using the “receive signal” primitive at the resource API and forwards answer status to the ISUP+ application component 94 using the “call progress” primitive at the peer-to-peer API. The ISUP+ application component 94 sends an ISUP+ address complete message using the “send signal” primitive at the resource API. The call is connected, and a dedicated two-way communication path exists between the subscriber's telephone 30 and the on-line stock service 36.

The local ISUP+ application component 92 receives the address complete message using the “receive signal” primitive at the resource API and forwards an answer status to the SIP application component 20 using the “answer” primitive at the peer-to-peer API. The SIP application component 90 uses the “send signal” primitive at the resource API to send an acknowledgement to the on-line service 36 indicating that the subscriber has answered the telephone 30.

Voice-synthesized stock-related data then is sent across the allocated Real Time Protocol (RTP)/IP stream 98 from the service 36 to the remote media gateway 24A over the backbone IP network 22. At the media gateway 24A, the IP cells are adapted from IP packets to a pulse code modulated (PCM) stream on an SS7 trunk circuit 100. At the PSTN circuit switch 28, the PCM stream is converted to an analog signal that is sent to the subscriber's telephone 30 so that the subscriber can listen to the stock information.

When the stock-quote transmission is complete, the stock-quote service 36 sends a SIP BYE message to the local softswitch 26C via the backbone IP network 22. The SIP application component 90 receives the SIP BYE message using the “receive signal” primitive at the resource API and forwards the release request to the ISUP+ application component 92 using the “hang-up” primitive at the peer-to-peer API. The ISUP+ application component 92 sends an ISUP+ REL message using the “send signal” primitive at the resource API. Call releases are released, and billing records can be generated.

The remote ISUP+ application component 94 receives the ISUP+ REL message using the “receive signal” primitive at the resource API and forwards the release request to the ISUP application component 96 using the “hang-up” primitive at the peer-to-peer API. The ISUP application component 96 sends a SS7 ISUP REL message to the PSTN circuit switch 28 using the “send signal” primitive at the resource API. Call resources are released, and billing records can be generated.

After listening to the stock information, the subscriber hangs up the telephone 30. The PSTN circuit switch 28 releases the call resources, receives the ISUP REL message and returns a SS7 ISUP RLC message. The SS7 trunk circuit then is available to handle a new call at the PSTN circuit switch 28.

The remote ISUP application component 96 receives the ISUP RLC message using the “receive signal” primitive at the resource API and sends release complete status information to the ISUP+ application component 94 using the “call completed” primitive at the peer-to-peer API. The ISUP+ application component 94 sends an ISUP+ RLC message using the “send signal” primitive at the resource API. The SS7 trunk circuit then is available to handle a new call at the remote softswitch 26A.

The local ISUP+ application component 94 receives the ISUP+ RLC message using the “receive signal” primitive at the resource API and sends release complete status to the SIP application component 90 using the “call completed” primitive at the peer-to-peer API. The SIP application component 90 sends a SIP message to the stock-quote service 36 to indicate that the call path and resources have been released.

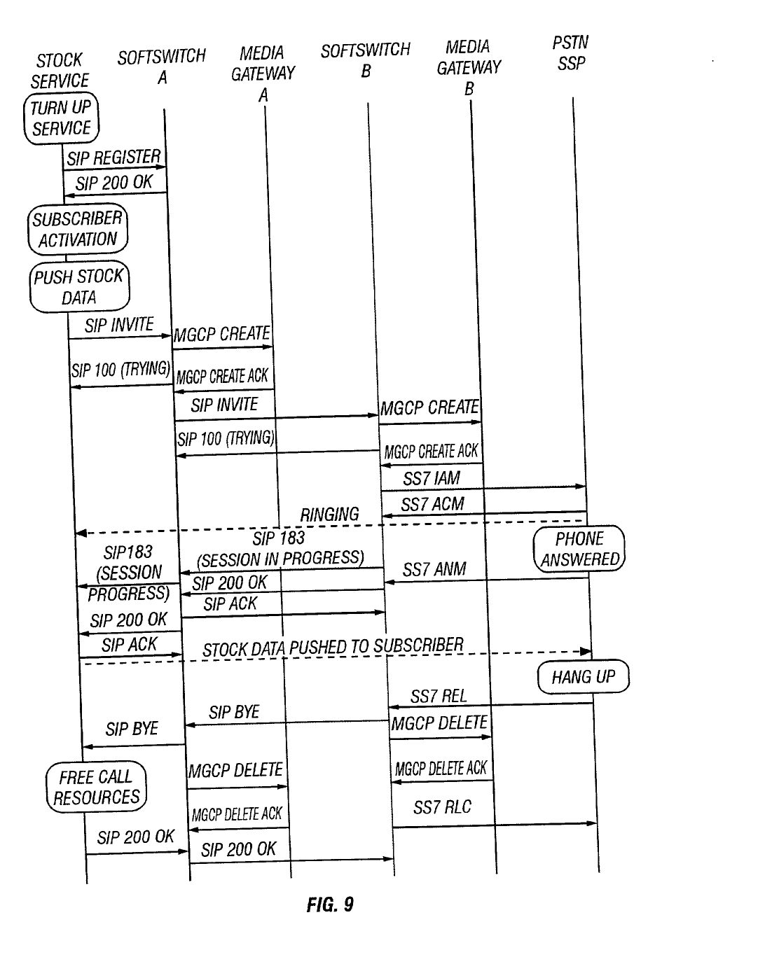

Instead of exchanging ISUP signals between the softswitches 26A, 26C, the softswitches can exchange SIP signals as shown in FIG. 9.

Various features of the system can be implemented in hardware, software, or a combination of hardware and software. For example, some aspects of the system can be implemented in computer programs executing on programmable computers that include one or more processors. Each program can be implemented in a high level procedural or object-oriented programming language to communicate with a computer system. Furthermore, each such computer program can be stored on a storage medium, such as read-only-memory (ROM), that is readable by a general or special purpose programmable computer, for configuring and operating the computer when the storage medium is read by the computer to perform the functions described above.

Other implementations are within the scope of the following claims.

What is claimed is:

1. A method comprising:
downloading a call service component to a call controller; and
using the call service component to support telecommunication traffic to or from a gateway under control of the call controller.

2. The method of claim 1 including dynamically downloading the call service component when a network carrier turns on a service, corresponding to the call service component, for a particular user area.

3. The method of claim 2 including dynamically removing the call service component from the call controller.

4. The method of claim 1 wherein the call service component uses a half-call model that views a call either as an originating or a terminating segment of the call.

5. The method of claim 4 including downloading the call service component from a central repository.

6. The method of claim 4 wherein each segment of the call handles service and access protocols according to a previously downloaded call service component with which the segment is associated.

7. The method of claim 4 wherein each call service component comprises a wrapper surrounding a set of core functions, wherein the wrapper supports dynamic downloading of the component to the call controller.

8. The method of claim 1 wherein downloading the call service occurs while the call controller is operational and supporting live traffic, the call service being downloaded without disrupting the live traffic.

9. The method of claim 1 wherein the call service component comprises an application component for implementing call behavior.

10. The method of claim 1 wherein the call service component comprises a resource component for providing access to telephony resources by an application component that implements call behavior.

11. The method of claim 4 including establishing a call having an originating segment that uses the call service component downloaded to the call controller.

12. The method of claim 11 wherein the call service component downloaded to the call controller represents a first call type, and wherein the call has a terminating segment that represents a different call type.

13. The method of claim 4 including establishing a call having a terminating segment that uses the call service component downloaded to the call controller.

14. The method of claim 13 wherein the call service component downloaded to the call controller represents a first call type, and wherein the call has an originating segment that represents a different call type.

15. A telecommunication system comprising:
a repository of call service components;
a call controller; and
a gateway under control of the call controller;
wherein the call controller is configured for:
downloading a call service component from the repository; and
using the call service component to support telecommunication traffic to or from the gateway.

16. The system of claim 15 including a telecommunications network, wherein the call controller is configured for dynamically downloading the call service component when a network carrier turns on a service, corresponding to the call service component, for a particular user area in the network.

17. The system of claim 16 wherein the call controller is configured for dynamically removing the call service component when the network carrier shuts off the service corresponding to the call service component for the particular user area in the network.

18. The system of claim 15 wherein each call service component uses a half-call model that views a call either as an originating or a terminating segment of the call.

19. The system of claim 18 each segment of the call handles service and access protocols according to a previously downloaded call service component with which the segment is associated.

20. The system of claim 18 wherein each call service component comprises a wrapper surrounding a set of core functions, wherein the wrapper supports dynamic downloading of the component to the call controller.

21. The system of claim 18 wherein the call controller is configured for downloading the call service while the call controller is operational and supporting live traffic, the call service being downloadable without disrupting the live traffic.

22. The system of claim 15 wherein the call service components stored in the repository that can be downloaded to the call controller comprise application components for implementing call behavior and resource components for providing access to telephony resources by the application components.

23. An article comprising a computer-readable medium storing computer-readable instructions for causing a computer system to:
download a particular call service component from a repository of call service components; and
use the particular call service component to support telecommunication traffic to or from a gateway under control of a call controller.

24. The article of claim 23 including instructions for causing the computer system to dynamically download the call service component when a network carrier turns on a service corresponding to the particular call service component for a particular user area.

25. The article of claim 24 including instructions for causing the computer system to dynamically remove the particular call service component when the network carrier shuts off the service corresponding to the particular call service component for the particular user area in the network.

26. The article of claim 23 wherein each call service component uses a half-call model that views a call either as an originating or a terminating segment of the call.

27. The article of claim 23 wherein each segment of the call handles service and access protocols according to a previously downloaded call service component with which the segment is associated.

28. The article of claim 23 wherein each call service component comprises a wrapper surrounding a set of core functions, wherein the wrapper supports dynamic downloading of the component from the repository.

29. The article of claim 23 including instructions for causing the computer system to download the particular call service while the call controller is operational and supporting live traffic, the call service being downloaded without disrupting the live traffic.

30. The article of claim 23 wherein the particular call service component comprises an application component for implementing call behavior.

31. The article of claim 30 wherein the particular call service component comprises a resource component for providing access to telephony resources by an application component that implements call behavior.

32. The article of claim 23 including instructions for causing the computer system to establish a call having an originating segment that uses the particular call service component downloaded from the repository.

33. The article of claim 23 including instructions for causing the computer system to establish a call having a terminating segment that uses the particular call service component downloaded from the repository.
